(19) United States
(12) Patent Application Publication
(10) Pub. No.: US 2025/0055351 A1
(43) Pub. Date: Feb. 13, 2025

(54) MOTOR AND ELECTRICAL PRODUCT

(71) Applicant: NIDEC CORPORATION, Kyoto (JP)

(72) Inventor: Chongyang WANG, Dalian (CN)

(21) Appl. No.: 18/796,761

(22) Filed: Aug. 7, 2024

(30) Foreign Application Priority Data
Aug. 8, 2023 (CN) 202310996461.8

(51) Int. Cl. H02K 11/00; H02K 5/04; H02K 7/00; H02K 19/02

(52) U.S. Cl. CPC H02K 11/0094; H02K 5/04; H02K 7/003; H02K 19/02; H02K 2203/09

(57) ABSTRACT

A motor includes a rotor, a stator, a casing accommodating the rotor and the stator and including an opening in an axial end, an upper bus bar assembly including an upper bus bar holder mounted on an edge of the opening of the casing and an upper bus bar (including an upper bus bar terminal) held on the upper bus bar holder, and a lower bus bar assembly including a lower bus bar holder located on an axially lower side of the upper bus bar holder and a lower bus bar (including a lower bus bar terminal) held on the lower bus bar holder. The upper bus bar terminal and the lower bus bar terminal are electrically connected inside the casing.

### CROSS-REFERENCE TO RELATED APPLICATIONS

The present application claims priority under 35 U.S.C. § 119 to Chinese Patent Application No. 202310996461.8, filed on Aug. 8, 2023, the entire contents of which are incorporated herein by reference.

### 1. FIELD OF THE INVENTION

The present application relates to the electromechanical field, in particular to motors and electrical products.

### 2. BACKGROUND

A brushless motor is equipped with a bus bar holder for providing power to the motor. In order to make a bus bar positioned more accurately, the bus bar holder is configured as an upper bus bar holder and a lower bus bar holder which are formed in a split manner, in which an upper bus bar held on the upper bus bar holder is electrically connected to the outside. Furthermore, the motor may be electrically connected to the outside by electrically connecting a terminal of the upper bus bar held on the upper bus bar holder to a terminal of a lower bus bar held on the lower bus bar holder.

Conventionally, the upper bus bar holder is usually mounted on a motor cover or on the lower bus bar holder.

It should be noted that the above introduction to the technical background is only for the convenience of a clear and complete description of the technical solutions of the present application, and for the convenience of understanding by those skilled in the art. It cannot be considered that the above technical solutions are known to those skilled in the art just because these solutions are described in the background section of the present application.

### SUMMARY

The inventors of the present application discovered that, since the upper bus bar holder is mounted on the motor cover, its position accuracy is affected by a dimension of the motor cover and assembly tolerance, resulting in certain deviation. Moreover, an electrical connection position between the upper bus bar terminal and the lower bus bar terminal is located outside the motor cover. Therefore, a through hole should be formed in the motor cover, which has a certain impact on dustproof and waterproof performance of the motor. Example embodiments of the present application have been made to ensure installation accuracy, and improve dustproof and waterproof performances.

According to a first aspect of example embodiments of the present application, a motor is provided. The motor includes a rotor including a rotating shaft rotatable about a central axis, a stator radially opposite the rotor, a casing accommodating the rotor and the stator and including an opening in an axial end, an upper bus bar assembly including an upper bus bar holder and an upper bus bar held on the upper bus bar holder, the upper bus bar including an upper bus bar terminal, and a lower bus bar assembly including a lower bus bar holder and a lower bus bar held on the lower bus bar holder, the lower bus bar including a lower bus bar terminal. The upper bus bar holder is mounted on an edge of the opening of the casing. The lower bus bar holder is located on an axially lower side of the upper bus bar holder. The upper bus bar terminal and the lower bus bar terminal are electrically connected inside the casing.

According to a second aspect of example embodiments of the present application, the motor further includes an inductive magnetic ring, in which the inductive magnetic ring is located on a radially inner side of the upper bus bar holder and is closer to the axially lower side than an upper surface of the upper bus bar holder.

According to a third aspect of example embodiments of the present application, the motor further includes an inductive magnetic ring, in which the inductive magnetic ring is located on an axially upper side of an electrical connection position between the upper bus bar terminal and the lower bus bar terminal.

According to a fourth aspect of example embodiments of the present application, the upper bus bar holder further includes a mounting portion, the mounting portion being located on the inner circumference of the upper bus bar holder and located on a radially outer side of the rotor. The mounting portion is integrally provided with the upper bus bar holder. The mounting portion is closer to the axially lower side than the electrical connection position between the upper bus bar terminal and the lower bus bar terminal, and is circumferentially opposite to the electrical connection position.

According to a fifth aspect of example embodiments of the present application, the motor further includes a circuit board, the circuit board being mounted on the mounting portion and located on the radially outer side of the rotor. The circuit board is located at a same height in the axial direction as the electrical connection position, and is opposite to the electrical connection position in a circumferential direction.

According to a sixth aspect of example embodiments of the present application, the mounting portion is at least partially annular in shape, and its inner circumferential diameter is greater than or equal to that of an iron core of the stator. The circuit board is at least partially annular in shape, and its inner circumferential diameter is greater than or equal to that of the mounting portion.

According to a seventh aspect of example embodiments of the present application, the motor further includes signal lines integral with the upper bus bar holder. One end of each of the signal lines is connected to the circuit board and portions of the signal lines extending on a plane perpendicular to an axial direction are located on a same plane.

According to an eighth aspect of example embodiments of the present application, the portions of the signal lines extending on the plane perpendicular to the axial direction are closer to the radially outer side relative to the circuit board and are closer to the radially inner side relative to a radially outer circumference of an edge of the casing.

According to a ninth aspect of example embodiments of the present application, at least a portion of the signal lines overlaps with an edge of the casing in an axial direction.

According to a tenth aspect of example embodiments of the present application, an electrical product is provided. The electrical product includes the motor described in any one of the first aspect to the ninth aspect.

With reference to the following description and accompanying drawings, specific implementations of the present application are disclosed in detail to indicate a manner in which the principles of the present application may be used. It should be understood that the implementations of the present application are not limited thereby in scope. Implementations of the present application encompass many changes, modifications and equivalents within the scope of the terms of the appended claims.

Features described and/or illustrated with respect to one implementation may be used in the same or similar manner in one or more other implementations, in combination with, or instead of features in other implementations.

It should be emphasized that the term “include/comprise” when used herein refers to the presence of a feature, integer, step or assembly, but does not exclude the presence or addition of one or more other features, integers, steps or assemblies.

The above and other elements, features, steps, characteristics and advantages of the present disclosure will become more apparent from the following detailed description of the example embodiments with reference to the attached drawings.

### BRIEF DESCRIPTION OF THE DRAWINGS

Elements and features described in one accompanying drawing or one implementation of example embodiments of the present application may be combined with elements and features shown in one or more other accompanying drawings or implementation. Furthermore, in the accompanying drawings, like numerals indicate corresponding components in the several accompanying drawings and may be used to indicate corresponding components used in more than one implementation.

The included accompanying drawings are used to provide a further understanding of the example embodiments of the present application, which are part of the description to illustrate the implementations of the present application, and explain the principles and example embodiments of the present application together with the text description. The accompanying drawings in the following description are only some of the example embodiments of the present application and include the following drawings.

FIG. 1 is a schematic diagram of an axial section of a motor according to an example embodiment of the present application.

FIG. 2 is a top view of the motor shown in FIG. 1.

FIG. 3 is another top view of the motor shown in FIG. 1.

FIG. 4 is a top view of the motor shown in FIG. 1 including a circuit board.

FIG. 5 is a top view of an upper bus bar holder of the motor shown in FIG. 1 from which a resin molded member is removed.

### DETAILED DESCRIPTION

The foregoing and other features of example embodiments of the present application will become apparent from the following description with reference to the accompanying drawings. In the description and accompanying drawings, specific implementations of the present application are disclosed, which indicate some implementations in which the principles of the present application can be adopted. It should be understood that the present application is not limited to the described implementations. On the contrary, the present application includes all modifications, variations and equivalents that fall within the scope of the appended claims. Various implementations of the present application will be described below with reference to the accompanying drawings. These implementations are only exemplary, but not intended to limit the present application.

In the example embodiments of the present application, the terms “first”, “second”, “upper”, “lower”, etc. are used to distinguish different elements from the names, but do not indicate a spatial arrangement or chronological order of these elements, etc., and these elements should not be limited by these terms. The term “and/or” includes any one and all combinations of one or more of the associated listed terms. The terms “comprising”, “including”, “having” and the like refer to the presence of stated features, elements, component or assemblies, but do not exclude the presence or addition of one or more other features, elements, components or assemblies.

In the example embodiments of the present application, the singular forms “a”, “this” and the like include plural forms, which should be broadly understood as “a kind” or “a class” and not limited to the meaning of “one”. In addition, the term “the” should be understood to include both the singular form and the plural form, unless the context clearly dictates otherwise. Furthermore, the term “according to” should be understood as “at least in part according to . . . ”; and the term “based on” should be understood as “at least in part based on . . . ”, unless the context clearly indicates otherwise.

In addition, in the following description of the example embodiments of the present application, for the convenience of description, a direction extending along a central axis of a motor or a direction parallel to this direction is referred to as an “axial direction”; a radius direction centered on the central axis is referred to as a “radial direction”; a direction around the central axis is referred to as a “circumferential direction”; a side away from the central axis in the radius direction is referred to as a “radially outer side”; a side close to the central axis in the radius direction is referred to as a “radially inner side”; a direction of the bottom of the motor casing pointing to an opening is referred to as “above”, “axially above”, “upper side” or “axially upper side”; and a direction of the opening of the motor casing pointing to the bottom of the motor casing is referred to as “below”, “axially below”, “lower side” or “axially lower side”. However, it is worth noting that these are for illustrative convenience only and do not limit the orientation of the motor when used and manufactured.

The example embodiments of the present application will be described below with reference to the accompanying drawings.

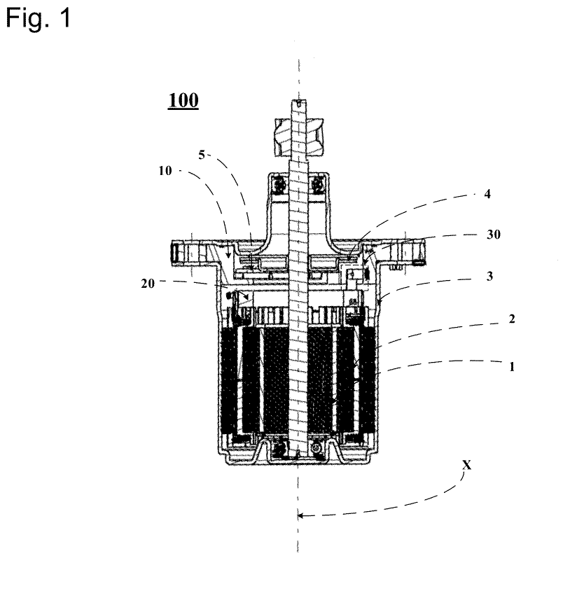

An example embodiment of the present application provides a motor 100. FIG. 1 is a schematic diagram of an axial section of the motor 100 in this example embodiment of the present application. As shown in FIG. 1, the motor 100 provided by this example embodiment of the present application includes a rotor 1, a stator 2 radially opposite the rotor 1, and a casing 3 accommodating the rotor 1 and the stator 2, in which the rotor 1 has a rotating shaft and is capable of rotatable about a central axis X of the rotating shaft, and the casing 3 has an opening in an axial end.

The motor 100 also has an upper bus bar assembly 10 and a lower bus bar assembly 20. The upper bus bar assembly 10 includes an upper bus bar holder and an upper bus bar held on the upper bus bar holder. The upper bus bar includes an upper bus bar terminal. The lower bus bar assembly includes a lower bus bar holder and a lower bus bar held on the lower bus bar holder. The lower bus bar includes a lower bus bar terminal.

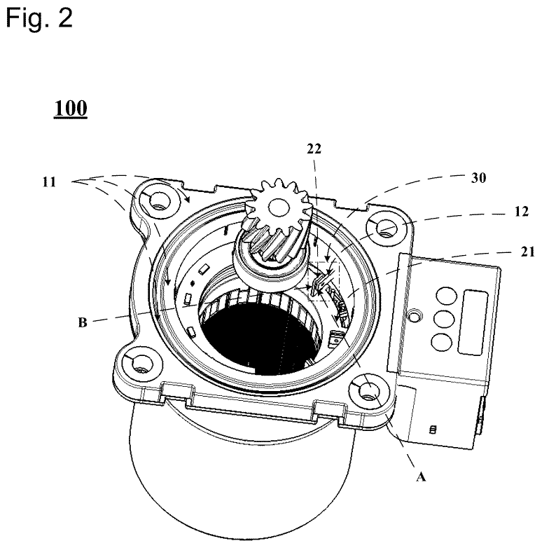

FIG. 2 is a top view of the motor 100 shown in FIG. 1. As shown in FIG. 1 and FIG. 2, the upper bus bar assembly 10 includes an upper bus bar holder 11 and an upper bus bar 12 held on the upper bus bar holder 11. The upper bus bar holder 11 is mounted on an edge of the casing 3. The upper bus bar terminal A is located inside the casing 3. As shown in FIG. 1 and FIG. 2, the casing 3 of the motor 100 in this example embodiment of the present application has a flange structure at the opening, which extends toward a radially outer side. The upper bus bar holder 11 can be in shape fit with this flange structure of the casing 3 and is mounted on this flange structure of the casing 3. The edge of the casing 3 refers to this flange structure.

However, this flange structure is only an example provided by this example embodiment of the present application. The casing 3 can also not have this flange structure, but only have an axially extending portion. In this example, the upper bus bar holder 11 is mounted on an upper edge of this axially extending portion. At this time, the edge of the casing 3 refers to the upper edge of this circumferentially extending portion. This is not limited in the present application.

As shown in FIG. 1 and FIG. 2, the lower bus bar assembly 20 includes a lower bus bar holder 21 and a lower bus bar 22 held on the lower bus bar holder 21. The lower bus bar holder 21 is disposed inside the casing 3 and is arranged axially below the upper bus bar holder 11. The lower bus bar terminal B and the terminal of the upper bus bar 12 are electrically connected inside the casing 3.

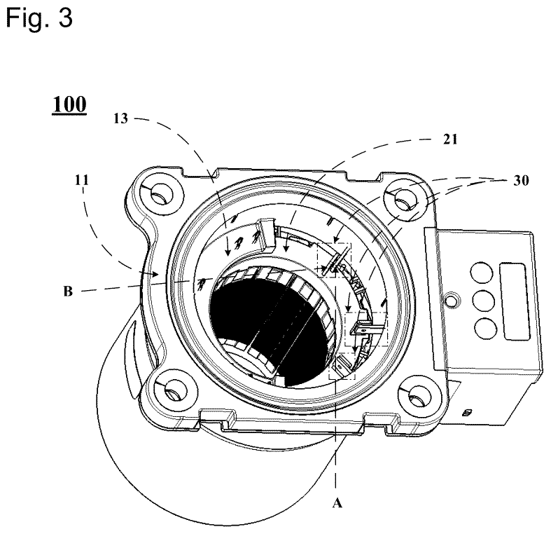

FIG. 3 is another top view of the motor 100 shown in FIG. 1. As shown in FIG. 2 and FIG. 3, the terminal of the upper bus bar 12 and the terminal of the lower bus bar 22 can be electrically connected at an electrical connection position 30, and the electrical connection position 30 is located inside the casing 3. In the motor 100 provided by this example embodiment of the present application, the upper and lower bus bar terminals may have a plurality of electrical connection positions 30. The number and specific positions of the electrical connection positions 30 are not limited in the present application.

According to the motor 100 provided by the above example embodiment of the present application, by mounting the upper bus bar holder 11 on the edge of the motor casing 3, the upper bus bar holder 11 assembled into the motor casing 3 is axially positioned by means of the edge of the casing 3, without any assembly tolerance when the upper bus bar holder 11 is pressed into the casing 3, thus ensuring the installation position accuracy of the upper bus bar holder 11. In addition, since the electrical connection position 30 between the terminal of the upper bus bar 12 and the terminal of the lower bus bar 22 is located inside the motor casing 3, the dustproof and waterproof performances of the motor can be improved, without reserving an opening in the motor cover.

In some example embodiments, as shown in FIG. 1, the motor 100 further includes an inductive magnetic ring 4. The inductive magnetic ring 4 is disposed on a radially inner side of the upper bus bar holder 11, and an upper surface of the inductive magnetic ring 4 is closer to an axially lower side relative to an upper surface of the upper bus bar holder 11. As shown in FIG. 1, the upper surface of the upper bus bar holder 11 refers to an axial upper surface, that extends radially, of the upper bus bar holder 11 mounted on the flange of the casing 3. Therefore, the inductive magnetic ring 4 is also disposed inside the casing, thereby reducing the dimension of the motor 100 in an axial direction.

In some example embodiments, as shown in FIG. 1, the inductive magnetic ring 4 is disposed on an axially upper side of the electrical connection position 30 between the upper and lower bus bar terminals, thereby facilitating the terminals of the upper bus bar 12 and the lower bus bar 22 to be connected inside the motor casing 3. Therefore, there is no need to reserve an opening in the motor cover, and further the dustproof and waterproof performances of the motor can be improved through a simple assembly process.

In the above example embodiment, the induction magnetic ring 4 can be arranged inside the casing 3 of the motor 100 by interference fit with the rotating shaft, or the inductive magnetic ring 4 may also be provided in the motor 100 with reference to the relevant technology in this field, which will not be limited in the present application.

In some example embodiments, as shown in FIG. 3, the upper bus bar holder 11 further has a mounting portion 13 for mounting the circuit board. The mounting portion 13 is disposed on the inner circumference of the upper bus bar holder 11 and located on a radially outer side of the rotor 1, and the mounting portion 13 may be integrally formed with the upper bus bar holder 11.

In the above example embodiment, as shown in FIG. 3, the mounting portion 13 is closer to the axially lower side than the electrical connection position 30 between the upper bus bar terminal A and the lower bus bar terminal B, and is opposite to the electrical connection position 30 in a circumferential direction. That is to say, the position of the mounting portion 13 in the axial direction is lower than the electrical connection position 30, and the position of the mounting portion 13 in the circumferential direction does not coincide with the electrical connection position 30. With this structure, an axial dimension of the motor can be reduced.

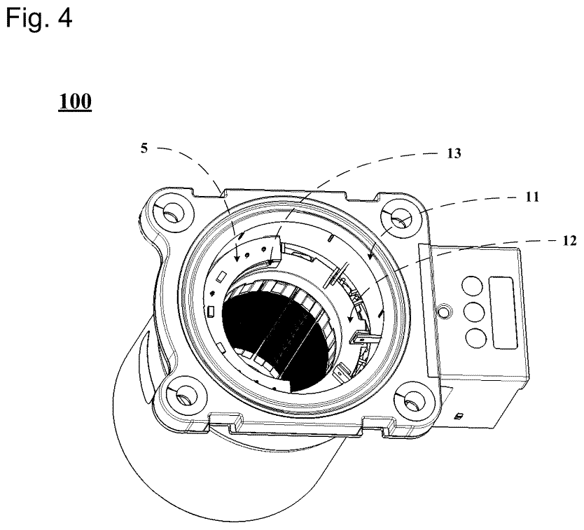

FIG. 4 is further another top view of the motor 100 shown in FIG. 1. As shown in FIG. 1 and FIG. 4, in this example embodiment of the present application, the motor 100 further includes a circuit board 5. In some example embodiments, the circuit board 5 is mounted on the mounting portion 13 and located on the radially outer side of the rotor 1. In the above example embodiment, the circuit board 5 is at the same height as the electrical connection position 30 in the axial direction, and is opposite to the electrical connection position 30 in the circumferential direction. This structure facilitates the assembly of the circuit board and can reduce the axial dimension of the motor.

In some example embodiments, as shown in FIG. 3, the mounting portion 13 is formed in a partially annular shape, and extends radially along an inner circumference of the upper bus bar holder 11 facing the inside of the casing 3. The partially annular shape of the mounting portion 13 has an inner circumferential diameter greater than or equal to that of an iron core of the stator 2. In addition, as shown in FIG. 4, the circuit board 5 is also formed in a partially annular shape, and the circuit board 5 has an inner circumferential diameter greater than or equal to that of the mounting portion 13, thereby preventing the circuit board 5 from interfering with the assembly of the rotor 1 and the stator 2.

In the above example embodiment, the height of the circuit board 5 in the axial direction is the same as the height of the electrical connection position 30 in the axial direction. Therefore, the dimension of the motor 100 in the axial direction can be further reduced.

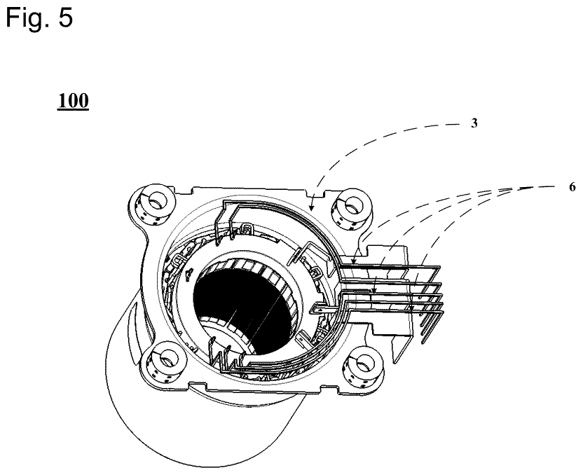

FIG. 5 is a top view of an upper bus bar holder of the motor 100 shown in FIG. 1 from which a resin molded member is removed. As shown in FIG. 5, in some example embodiments, the motor 100 also has a plurality of signal lines 6. The plurality of signal lines 6 is integrally formed on the upper bus bar holder 11. In addition, one end of each of the plurality of signal lines 6 is connected to the circuit board 5, and the other end of the signal line extends along the casing 3 toward the outside of the motor 100. As shown in FIG. 5, the plurality of signal lines 6 each has a portion extending on a plane perpendicular to the axial direction, in which the portions of the plurality of signal lines 6 extending on the plane perpendicular to the axial direction are located on the same plane. Therefore it can be ensured that the heights of the plurality of signal lines 6 in the axial direction are consistent, thereby further reducing an axial height of the upper bus bar holder 11 and further reducing the axial dimension of the motor 100.

In the above example embodiment, the specific number of the plurality of signal lines 6 can be specifically set according to the structure and needs of the motor 100, which will not be limited in the present application.

In addition, in the above example embodiment, the portions of the plurality of signal lines 6 extending on the plane perpendicular to the axial direction may be closer to the radially outer side than the circuit board 5 and closer to the radially inner side than the radially outer circumference of the edge of the casing 3. That is to say, as shown in FIG. 5, the portions of the plurality of signal lines 6 extending on the plane perpendicular to the axial direction are located between the outer circumference of the partially annular circuit board 5 and the outermost circumference of the flange structure on the edge of the casing 3. Therefore, a space on the radially inner side of the circuit board is not occupied, and the assembly of the motor can be facilitated.

In some example embodiments, at least part of the plurality of signal lines 6 can overlap with the edge of the casing 3 in the axial direction, thereby further making full use of a radial space of the flange structure on the edge of the casing 3, and at the same time, preventing the plurality of signal lines 6 from affecting the arrangement of components in the internal space of the motor 100.

It is worth noting that the above content is only an exemplary description of the composition and structure of the motor related to the present application, but the present application is not limited thereto, and appropriate variations can also be made on the basis of the above example embodiments. In addition, the above content only exemplarily describes respective components, but the present application is not limited thereto, and the specific content of the respective components can also refer to related technologies. The motor may also include other components, such as an end cover and a bearing. For details, reference may be made to related technologies, which will be omitted here.

As can be seen from the above example embodiment, by mounting the upper bus bar holder on the edge of the motor casing, there is no assembly tolerance between the position of the edge of the casing and the motor cover and the lower bus bar holder, thus ensuring the installation position accuracy of the upper bus bar holder. In addition, since the electrical connection position between the upper bus bar terminal and the lower bus bar terminal is located inside the motor casing, the dustproof and waterproof performances of the motor can be improved. In addition, since the electrical connection positions between the terminals of the upper and lower bus bars are located inside the motor, the axial dimension of the motor can also be reduced.

An example embodiment of the present application provides an electrical product. The electrical product includes the motor 100 described in the foregoing example embodiment of the first aspect.

Since the structure of this motor 100 has been described in detail in the example embodiment of the first aspect, its content is incorporated here, which will be omitted here.

In the implementation of the present application, the electrical product may be any electrical device equipped with a motor, such as a brake motor.

The present application is described above in conjunction with specific implementations, but those skilled in the art should be clear that these descriptions are exemplary and are not intended to limit the protection scope of the present application. Those skilled in the art can make various variations and modifications to the present application according to the spirit and principles of the present application, and these variations and modifications are also within the scope of the present application.

The preferred implementations of the present application are described above with reference to the accompanying drawings. Many features and advantages of these implementations are clear according to the detailed description. Therefore, the accompanying claims are intended to cover all these features and advantages that fall within the true spirit and scope of these implementations. Furthermore, since those skilled in the art is prone to think of many modifications and changes, it is not intended to limit the implementations of the present application to the precise structure and operations shown and described, but to cover all suitable modifications and equivalents that fall within its scope.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor including a rotating shaft rotatable about a central axis;
a stator radially opposite the rotor;
a casing accommodating the rotor and the stator and including an opening in an axial end;
an upper bus bar assembly including an upper bus bar holder and an upper bus bar held on the upper bus bar holder, the upper bus bar including an upper bus bar terminal; and
a lower bus bar assembly including a lower bus bar holder and a lower bus bar held on the lower bus bar holder, the lower bus bar including a lower bus bar terminal; wherein
the upper bus bar holder is mounted on an edge of the opening of the casing;
the lower bus bar holder is located on an axially lower side of the upper bus bar holder; and
the upper bus bar terminal and the lower bus bar terminal are electrically connected inside the casing.

2. The motor according to claim 1, further comprising:
an inductive magnetic ring; wherein
the inductive magnetic ring is located on a radially inner side of the upper bus bar holder and is closer to the axially lower side relative to an upper surface of the upper bus bar holder.

3. The motor according to claim 1, further comprising:
an inductive magnetic ring; wherein
the inductive magnetic ring is located on an axially upper side of an electrical connection position between the upper bus bar terminal and the lower bus bar terminal.

4. The motor according to claim 1, wherein
the upper bus bar holder further includes a mounting portion;
the mounting portion is located on an inner circumference of the upper bus bar holder and located on a radially outer side of the rotor;
the mounting portion is integrally provided with the upper bus bar holder; and
the mounting portion is closer to the axially lower side than the electrical connection position between the upper bus bar terminal and the lower bus bar terminal, and is circumferentially opposite to the electrical connection position.

5. The motor according to claim 4, further comprising a circuit board; wherein
the circuit board is mounted on the mounting portion and is located on a radially outer side of the rotor; and
the circuit board is located at a same height in the axial direction as the electrical connection position, and is opposite to the electrical connection position in a circumferential direction.

6. The motor according to claim 5, wherein
the mounting portion is at least partially annular in shape, and its inner circumferential diameter is greater than or equal to that of an iron core of the stator; and
the circuit board is at least partially annular in shape, and its inner circumferential diameter is greater than or equal to that of the mounting portion.

7. The motor according to claim 1, further comprising:
signal lines integral with the upper bus bar holder; wherein
one end of each of the signal lines is connected to the circuit board; and
portions of the signal lines extending on a plane perpendicular to an axial direction are located on a same plane.

8. The motor according to claim 7, wherein the portions of the signal lines extending on the plane perpendicular to the axial direction are closer to the radially outer side relative to the circuit board and are closer to the radially inner side relative to a radially outer circumference of an edge of the casing.

9. The motor according to claim 7, wherein at least a portion of the signal lines overlaps with an edge of the casing in an axial direction.

10. An electrical product comprising the motor according to claim 1.
